(19) United States
(12) Patent Application Publication
(10) Pub. No.: US 2018/0356144 A1
(43) Pub. Date: Dec. 13, 2018

(54) Fruit And Vegetable Storage Device

(71) Applicant: Victor Enriquez, Aurora, IL (US)

(72) Inventor: Victor Enriquez, Aurora, IL (US)

(21) Appl. No.: 15/840,992

(22) Filed: Dec. 13, 2017

Related U.S. Application Data
(60) Provisional application No. 62/433,420, filed on Dec. 13, 2016.

(51) Int. Cl. F25D 17/04; B65D 81/24; B65D 85/34; B65B 25/04

(52) U.S. Cl. CPC F25D 17/045; B65D 81/24; A23B 7/04; B65B 25/041; F25D 2317/061; B65D 85/345

(57) ABSTRACT

A fruit and vegetable storage device for storing fruit and vegetables is provided. The storage device comprises a housing having a base unit, a side wall extending from the base and defining an inner chamber and a top wall enclosing the side wall opposite the base unit. A plurality of baskets are suspended vertically within the inner chamber with the fruit and vegetables of various sizes storable within the baskets. A motor is mounted within the base unit and a refrigeration system is electrically connected to the motor for providing refrigeration to the inner chamber. The baskets within the housing better stores fruits and vegetables at a regulated temperature, free of exposures that cause premature spoilage.

### CLAIM OF PRIORITY

This patent application claims priority under 35 USC 119 (e) (1) from U.S. Provisional Patent Application Ser. No. 62/433,420 filed Dec. 13, 2016, of common inventorship herewith entitled, “Fruit Life,” which is incorporated herein by reference as though the same were set forth in its entirety.

### FIELD OF THE INVENTION

The present invention pertains to the field of fruit and vegetable storage devices, and more specifically to the field of motorized, temperature-controlled fruit and vegetable storage devices specially designed for housing fruits and vegetables.

### BACKGROUND OF THE INVENTION

For many Americans, fresh produce is a preferred form of sustenance. Whether growing cucumbers and squash in a backyard garden, plucking apples and oranges from lofty trees, or simply squeezing tomatoes and thumping melons in a supermarket, consumers are constantly on the lookout for the freshest fruits and vegetables to serve and enjoy as a snack, entree, or dessert. As garden fresh produce is nutritious as well as delicious, both the National Cancer Institute (NCI) and the National Institutes of Health (NIH) recommend that individuals consume five servings of fruits and vegetables every day. In fact, studies have shown that the positive benefits of increased vegetable and fruit consumption include reduced risk of coronary heart disease, stroke, and obesity. In addition, other scientific studies have demonstrated that greater fruit and vegetable consumption is consistent with a reduced risk of some types of cancers, including cancer of the stomach, esophagus, and lung. Bursting with both nutritional and taste benefits, it is no wonder that fresh produce is a favorite among health conscious consumers.

While confident that good vegetables and fruits are good for them, the majority of people make sure to wash fresh produce at home prior to eating. Concerned about contaminants such as dirt, pesticides, wax, and handling residue, people will usually run water over the items in an effort to rid the food of these potentially harmful substances. Many take the fruit and vegetable cleaning task a step further by employing a brush to ensure the eradication of any foreign matter. Although these Methods are very effective in assuring good, quality food, many people do not realize that the last tool in maintaining fruit and vegetable freshness can present a drawback: the household refrigerator.

Until ready to eat, produce is normally placed in the refrigerator's crisper, a separate compartment that helps keep the temperature regulated to maximize freshness. While sufficiently sized to hold a plethora of produce, crispers can prove detrimental in that they do not keep excess moisture from forming on the food. As such, tomatoes and heads of lettuce can begin to bruise and brown quickly, and cucumbers and fresh peaches can rapidly become watery messes. Unfortunately, when these foods are left exposed in the refrigerator, it can result in food items that are spoiled before they can be enjoyed.

The prior art has put forth several designs for fruit storage. Among these are:

U.S. Pat. No. 4,358,935 to Gehard Losert et al provides an improved storage assembly for use in preserving and rejuvenating items such as vegetables and the like in a refrigerator maintained at a temperature of between 33° F. and 58° F. by surrounding the items with a fog composed of water particles having a diameter of between 1 and 20 microns generated by means of an ultrasonic wave nebulizer with a transducer element. The storage assembly includes a cover and a pan in sealing arrangement with the cover and movable relative thereto. A water reservoir is located in close proximity to the pan and has the transducer element of the ultrasonic wave nebulizer in communication with water in the reservoir for generating the water particle fog. A passageway is provided for delivering the fog from the interior of the reservoir to the interior of the pan. Electrical connection means for enabling the nebulizer is provided along with timer means to periodically energize and deenergize the nebulizer during the time the electrical connection means would enable the nebulizer.

U.S. Pat. No. 7,296,422 to Andrew G. Strohm et al provides a refrigerated unit for storing fruits and vegetables. A household-sized refrigerated unit includes a storage space for retaining fruits and vegetables. The temperature within the storage space is controllable within a range of approximately 40-65 degrees Fahrenheit. The humidity level within the storage space is regulated to prevent unnecessary desiccation of the fruit and vegetables, and to prevent excessive condensation. The unit is provided with a mechanism for regulating the level of ethylene gas within the storage space to either retard or accelerate ripening, as desired.

U.S. Pat. No. 6,591,623 to Young-Gil Lee provides a compound type Kim-chi refrigerator having a heater composed of the electrically heated wire to the backside of a vertical partition wall defining vegetable chamber for maintaining the temperature of the vegetable chamber within a predetermined temperature range and removing the frost within the vegetable chamber. The compound type Kim-chi refrigerator according to the present invention comprise a heater 9 attached to the lower part of the condensed water vent formed on the vertical partition wall 6b defining the vegetable chamber 61 to remove the frost and heat the vegetable chamber 61 properly to the predetermined temperature range.

None of these prior art references describe the present invention.

### SUMMARY OF THE INVENTION

It is an object of the present invention to provide a motorized, temperature-controlled fruit and vegetable storage device specially designed for housing fruits and vegetables.

The present invention is a fruit and vegetable storage device for storing fruit and vegetables. The storage device comprises a housing having a base unit, a side wall extending from the base and defining an inner chamber, and a top wall enclosing the side wall opposite the base unit. A plurality of baskets are suspended vertically within the inner chamber with the fruit and vegetables of various sizes storable within the baskets. A motor is mounted within the base unit and a refrigeration system is electrically connected to the motor for providing refrigeration to the inner chamber. The baskets within the housing better stores fruits and vegetables at a regulated temperature, free of exposures that cause premature spoilage.

In addition, the present invention includes a method for storing fruit and vegetables. The method comprises providing housing having a base unit, a side wall extending from the base and defining an inner chamber, and a top wall enclosing the side wall opposite the base unit, vertically suspending a plurality of baskets within the inner chamber, storing the fruit and vegetables of various sizes within the baskets, mounting a motor within the base unit, electrically connecting a refrigeration system to the motor, providing refrigeration to the inner chamber from the refrigeration system, and storing the fruits and vegetables at a regulated temperature, free of exposures that cause premature spoilage.

The present invention further includes a fruit and vegetable storage device for storing fruit and vegetables. The storage device comprises a housing having a base unit, a side wall extending from the base and defining an inner chamber, and a top wall enclosing the side wall opposite the base unit. An opening is formed in the side wall of the housing between the base unit and the top wall. A door is movable to open and close the opening. A plurality of baskets are suspended vertically within the inner chamber with the fruit and vegetables of various sizes storable within the baskets. A motor is mounted within the base unit and a refrigeration system is electrically connected to the motor for providing refrigeration to the inner chamber. A digital display screen is positioned on an outside surface of the base unit for displaying the internal temperature within the inner chamber and other pertinent information. At least one button or switch is mounted on an outside surface of the base unit allowing for raising and lowering the internal temperature within the inner chamber the refrigeration system. A plurality of slots is formed in a top surface of the base unit of the housing allowing the flow of cool air from the refrigeration system within the base unit to the inner chamber of the housing. The baskets within the housing better stores fruits and vegetables at a regulated temperature, free of exposures that cause premature spoilage.

### BRIEF DESCRIPTION OF THE DRAWINGS

FIG. 1 is a perspective view illustrating a fruit and vegetable storage device, constructed in accordance with the present invention.

FIG. 2 is another perspective view illustrating the fruit and vegetable storage device, constructed in accordance with the present invention.

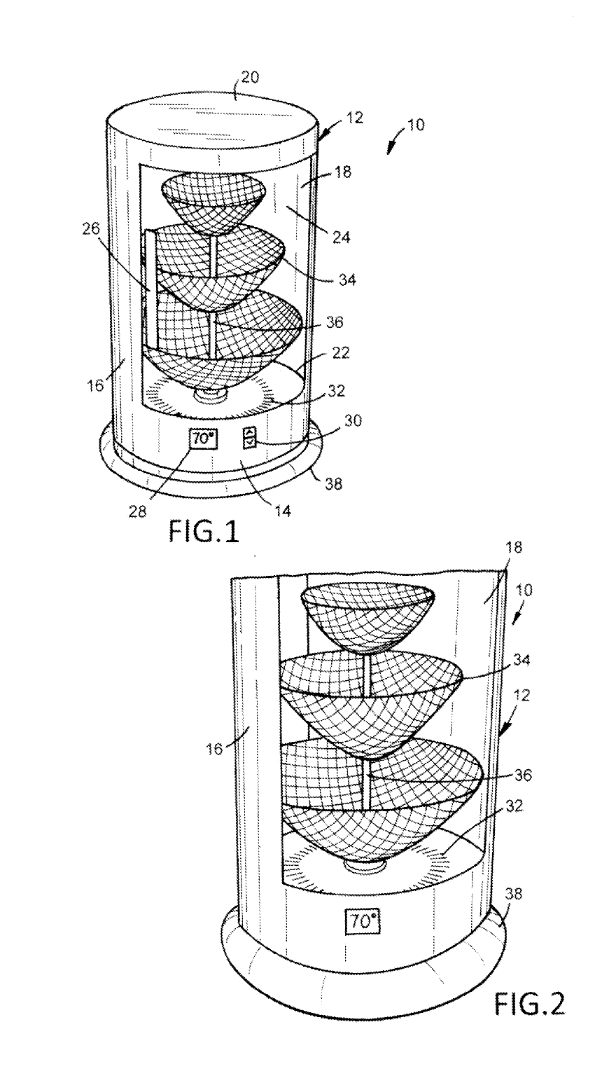

### DETAILED DESCRIPTION OF THE INVENTION

The present invention, hereinafter referred to as a Fruit and Vegetable Storage Device, indicated generally at 10, providing a motorized, temperature-controlled device specially designed for housing fruits and vegetables. As such, with the Fruit and Vegetable Storage Device 10, users are able to better store produce at a regulated temperature, free of exposures that cause premature spoilage.

The Fruit and Vegetable Storage Device 10 of the present invention includes a housing 12 having a base unit 14, a side wall 16 extending from the base unit 14 and defining an inner chamber 18, and a top wall 20 enclosing the side wall 16 opposite the base unit 14. Preferably, the housing 12 of the Fruit and Vegetable Storage Device 10 is a circular unit standing in a vertical fashion. It should be noted that while the housing 12 has been described as being substantially circular, it is within the scope of the present invention for the housing 12 to be any shape including, but not limited to, square, rectangular, etc. The side wall 16 of the housing 12 can be constructed of glass or other durable material such as metal or plastic. An opening 22 is formed in the side wall 16 between the base unit 14 and the top wall 20 with a door 24 movable to open and close the opening 22. Preferably, the door 24 has a handle 26 for easy operation of the door 24 and preferably is a double glass door 24 allowing ingress and egress into the inner chamber 22 of the housing 12.

The base unit 14 of the Fruit and Vegetable Storage Device 10 of the present invention houses the unit's motor and refrigeration system. A handy digital display screen 28 is positioned on the outside of the base unit 14 for displaying the internal temperature within the inner chamber 22 and other pertinent information. The base unit 14 further has buttons 30 and/or switches allowing for raising and lowering the internal temperature within the inner chamber 22 by the refrigeration system. As an electrical appliance, the Fruit and Vegetable Storage Device 10 operates on conventional 110 volts, 60 hertz power and is connected to a standard power outlet.

A plurality of slots 32 or other apertures are formed in a top surface of the base unit 14 of the housing 12 of the Fruit and Vegetable Storage Device 10 of the present invention allowing the flow of cool air from the refrigeration system within the base unit 14 to the inner chamber 22 of the housing 14. Preferably, the slots 32 are aligned concentrically about the base unit 14 for the even flow and distribution of the cooled air about the fruit and vegetables from the refrigeration system.

In addition, the Fruit and Vegetable Storage Device 10 of the present invention includes a plurality of baskets 34 or bins suspended vertically within the inner chamber 22 of the housing 12 allowing for storage of fruits and vegetables of various sizes. In a preferred embodiment, the Fruit and Vegetable Storage Device 10 includes three (3) ventilated baskets 34 of increasing width (large, medium, and small) with the large basket positioned near the base unit of the housing, the medium basket positioned directly above the large basket, and the small basket positioned above the medium basket. In an embodiment, the baskets 34 are rotatable about an axis pole 36 allowing the user to either rotate the baskets 34 together or independently of each other for each access and viewing of the fruit and vegetables stored therein.

The housing 12 of the Fruit and Vegetable Storage Device 10 of the present invention can be mounted on a swivel mount 38. The swivel mount 38 allows the entire housing 12 to rotate such that the user can move the housing 12 for better viewing and access.

Use and application of Fruit and Vegetable Storage Device 10 of the present invention is very simple and straightforward. First the user sets the appropriate temperature on the Fruit and Vegetable Storage Device, and then fills the baskets 34 with the chosen fruits and/or vegetables. By way of example, large zucchini or squash can be housed in the large bowl, while fresh apples or oranges and plums or cut asparagus can occupy the medium and small compartments, respectively. In this manner, each food item is nestled within its own housing, with the barrier walls of the bowls shielding them from the other produce. Moreover, when the food is placed in the temperature-controlled environment, the Fruit and Vegetable Storage Device 10 works to draw in any excess moisture that may begin forming on the fruit or vegetable. As such, when one is ready for a healthy snack, he or she simply removes the food from the unit, and enjoy a fruit or vegetable that is juicy or crisp, yet always fresh.

There are several significant benefits and advantages associated with the Fruit and Vegetable Storage Device 10 of the present invention. Foremost, the Fruit and Vegetable Storage Device 10 provides users with a simple yet effective means of prolonging the freshness of fruits and vegetables. A cleverly conceived household appliance, the Fruit and Vegetable Storage Device 10 eliminates the risk that these foods, since they are not stored in the refrigerator, will spoil from excess moisture. In this manner, any wetness that forms on delicate vegetables and fruits is absorbed by the powered environment of the Fruit and Vegetable Storage Device 10, which acts as a shield against moisture. As a result, users are assured that they will be able to enjoy fresh produce whenever it is retrieved. The Fruit and Vegetable Storage Device 10 also prevents the wasting of precious food items, prolonging the life of fruits and vegetables that are cultivated in one's own garden while also saving money in grocery replacement. Extremely easy to operate, items can be placed into and removed from the Fruit and Vegetable Storage Device 10 in a matter of seconds, thanks to its user-friendly design. While the Fruit and Vegetable Storage Device was primarily conceived with household users in mind, restaurants and other professional food establishments will surely appreciate the money saving benefits afforded by the Fruit and Vegetable Storage Device 10.

The Fruit and Vegetable Storage Device 10 of the present invention helps alleviate the hassles often encountered when storing fresh produce. Universal in design and application, the Fruit and Vegetable Storage Device 10 Life offers sizes appropriate for virtually any fruit or vegetable. Affordably priced, the Fruit and Vegetable Storage Device 10 will be well received by the general user populace, as well as restaurants and other dining establishments.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A fruit and vegetable storage device for storing fruit and vegetables, the storage device comprising:
a housing having a base unit, a side wall extending from the base and defining an inner chamber, and a top wall enclosing the side wall opposite the base unit;
a plurality of baskets suspended vertically within the inner chamber, the fruit and vegetables of various sizes storable within the baskets;
a motor mounted within the base unit; and
a refrigeration system electrically connected to the motor for providing refrigeration to the inner chamber;
wherein the baskets within the housing better stores fruits and vegetables at a regulated temperature, free of exposures that cause premature spoilage.

2. The storage device of claim 1 wherein the housing has a substantially circular cross-sectional configuration.

3. The storage device of claim 1 wherein the side wall of the housing is constructed of a glass material.

4. The storage device of claim 1 and further comprising:
an opening formed in the side wall of the housing between the base unit and the top wall.

5. The storage device of claim 4 and further comprising:
a door movable to open and close the opening.

6. The storage device of claim 5 and further comprising:
a handle mounted to the door.

7. The storage device of claim 1 and further comprising:
a digital display screen positioned on an outside surface of the base unit for displaying the internal temperature within the inner chamber and other pertinent information.

8. The storage device of claim I and further comprising:
at least one button or switch mounted on an outside surface of the base unit allowing for raising and lowering the internal temperature within the inner chamber by the refrigeration system.

9. The storage device of claim 1 and further comprising:
a plurality of slots are formed in a top surface of the base unit of the housing allowing the flow of cool air from the refrigeration system within the base unit to the inner chamber of the housing.

10. The storage device of claim 9 wherein the slots are aligned concentrically about the base unit for the even flow and distribution of the cooled air about the fruit and vegetables from the refrigeration system.

11. The storage device of claim 1 and further comprising:
three (3) ventilated baskets of increasing width (large, medium, and small) with the large basket positioned near the base unit of the housing, the medium basket positioned directly above the large basket, and the small basket positioned above the medium basket.

12. The storage device of claim 11 wherein the baskets are rotatable about an axis pole allowing the user to either rotate the baskets together or independently of each other for each access and viewing of the fruit and vegetables.

13. The storage device of claim 1 and further comprising:
a swivel mount mounted to the housing for rotating the housing.

14. A method for storing fruit and vegetables, the method comprising:
providing housing having a base unit, a side wall extending from the base and defining an inner chamber, and a top wall enclosing the side wall opposite the base unit;
vertically suspending a plurality of baskets within the inner chamber;
storing the fruit and vegetables of various sizes within the baskets;
mounting a motor within the base unit;
electrically connecting a refrigeration system to the motor;
providing refrigeration to the inner chamber from the refrigeration system; and
storing the fruits and vegetables at a regulated temperature, free of exposures that cause premature spoilage.

15. A fruit and vegetable storage device for storing fruit and vegetables, the storage device comprising:
a housing having a base unit, a side wall extending from the base and defining an inner chamber, and a top wall enclosing the side wall opposite the base unit;
an opening formed in the side wall of the housing between the base unit and the top wall;
a door movable to open and close the opening;
a plurality of baskets suspended vertically within the inner chamber, the fruit and vegetables of various sizes storable within the baskets;
a motor mounted within the base unit;
a refrigeration system electrically connected to the motor for providing refrigeration to the inner chamber;
a digital display screen positioned on an outside surface of the base unit for displaying the internal temperature within the inner chamber and other pertinent information;
at least one button or switch mounted on an outside surface of the base unit allowing for raising and lowering the internal temperature within the inner chamber by the refrigeration system; and
a plurality of slots formed in a top surface of the base unit of the housing allowing the flow of cool air from the refrigeration system within the base unit to the inner chamber of the housing;
wherein the baskets within the housing better stores fruits and vegetables at a regulated temperature, free of exposures that cause premature spoilage.

16. The storage device of claim 15 wherein the door is constructed of a glass material.

17. The storage device of claim 15 and further comprising:
a handle mounted to the door.

18. The storage device of claim 15 wherein the slots are aligned concentrically about the base unit for the even flow and distribution of the cooled air about the fruit and vegetables from the refrigeration system.

19. The storage device of claim 15 and further comprising:
three (3) ventilated baskets of increasing width (large, medium, and small) with the large basket positioned near the base unit of the housing, the medium basket positioned directly above the large basket, and the small basket positioned above the medium basket.

20. The storage device of claim 15 wherein the baskets are rotatable about an axis pole allowing the user to either rotate the baskets together or independently of each other for each access and viewing of the fruit and vegetables.
